(19) United States
(12) Patent Application Publication
(10) Pub. No.: US 2016/0041759 A1
(43) Pub. Date: Feb. 11, 2016

(54) STORAGE SYSTEM AND DATA TRANSMITTING METHOD THEREOF

(71) Applicant: THE-AIO CO., LTD., Seongnam-si, Gyeonggi-do (KR)

(72) Inventor: Seung-Hyun HAN, Seoul (KR)

(21) Appl. No.: 14/776,326

(22) PCT Filed: Dec. 23, 2013
(86) PCT No.: PCT/KR2013/012003

§ 371 Date: Sep. 14, 2015

(30) Foreign Application Priority Data
Mar. 15, 2013 (KR) 10-2013-0027846

(51) Int. Cl. G06F 3/06

(52) U.S. Cl. CPC G06F 3/061; G06F 3/0659; G06F 3/0679

(57) ABSTRACT

A storage system comprises: a storage device including a NAND flash memory and a storage controller for controlling the NAND flash memory, and a host device including a host controller for interacting with the storage controller and a file system for generating a read command or a write command for data pieces in the unit of blocks. At this time, when the read command or the write command for the data pieces is generated, the host device and the storage device transmit/receive the data pieces in the unit of data transmission corresponding to a sector size. When read data pieces are determined by the write command, the host device collects first space data pieces related to the write data pieces and transmits the first spare data pieces to the storage device first and then the write data pieces.

### BACKGROUND

1. Technical Field

Example embodiments relate generally to a semiconductor memory system. More particularly, embodiments of the present inventive concept relate to a storage system including a host device and a storage device (e.g., a NAND flash memory device) and a method of transmitting data between the host device and the storage device in the storage system.

2. Description of the Related Art

A semiconductor memory device may be classified into two types (i.e., a volatile memory device and a non-volatile memory device) according to whether data can be retained when power is not supplied. Recently, a NAND flash memory device is widely used as the non-volatile memory device because the NAND flash memory device can be manufactured smaller in size while having higher capacity. Thus, a storage device such as the NAND flash memory device (e.g., a solid state drive (SSD), etc) has been replacing a hard disk drive (HDD). Generally, the storage device includes at least one NAND flash memory and a storage controller that controls the NAND flash memory device. Specifically, the storage controller performs an address mapping operation, which translates a logical address into a physical address, based on a flash translation layer (FTL) for supporting a file system. In addition, the storage controller controls a read operation, a write operation, an erase operation, a merge operation, a copy-back operation, a compaction operation, a garbage collection operation, a wear leveling operation, and the like.

Meanwhile, the storage controller of the storage device interacts with a host controller of a host device. Here, the read operation and the write operation are performed by a block unit (e.g., 1 KB, 2 KB, 4 KB, etc) in the host device while the read operation and the write operation are performed by a specific unit (e.g., more than 16 KB) that is a multiple of the physical page of the NAND flash memory device (i.e., that is greater than the block unit) in the storage device. In addition, data are received and transmitted (i.e., a logical block-based interface) between the host device and the storage device by a data transmission unit corresponding to a sector size. Thus, in a conventional storage system, even when meta-data in a range from few bytes to tens of bytes are written to perform a power-off recovery operation, a transaction operation, etc, the host device needs to request the write operation to be performed on an additional block, and thus the request causes the storage device to perform the write operation on an additional physical page. In brief, since the write operation of about 4 KB is performed for the meta-data in a range from few bytes to tens of bytes when the power-off recovery operation, the transaction operation, etc are performed, the conventional storage system may be inefficient. In addition, performance and/or lifecycle of the conventional storage system including the NAND flash memory device may be degraded (or, reduced) by the erase operation following the write operation for the meta-data in a range from few bytes to tens of bytes.

### SUMMARY

Some example embodiments provide a storage system that can allow a host device to use a portion of a spare space of a physical page of a NAND flash memory included in a storage device while using a logical block-based interface.

Some example embodiments provide a method of transmitting data between a host device and a storage device in a storage system that can efficiently transmit read-data/write-data (i.e., main-data) and spare-data related to the main-data between the host device and the storage device in the storage system.

According to an aspect of example embodiments, a storage system may include a storage device including at least one NAND flash memory and a storage controller that controls the NAND flash memory and a host device including a host controller that interacts with the storage controller and a file system that generates a read command or a write command for data by a block unit on a logical address. Here, when the read command or the write command for the data is generated, the host device and the storage device may receive and transmit the data by a data transmission unit corresponding to a sector size. In addition, when write-data are determined based on the write command, the host device may transmit the write-data to the storage device after gathering and transmitting first spare-data related to the write-data to the storage device.

In example embodiments, the storage controller may include a flash translation layer that performs an address mapping operation.

In example embodiments, the host controller may include a host flash translation layer, the storage controller includes a storage flash translation layer, and the host flash translation layer and the storage flash translation layer perform an address mapping operation.

In example embodiments, the storage device may write the write-data into a main space of a physical page of the NAND flash memory and may write the first spare-data into a portion of a spare space of the physical page.

In example embodiments, the first spare-data may include information for performing a power-off recovery operation in connection with the write-data.

In example embodiments, the first spare-data may include information for performing a transaction operation in connection with the write-data.

In example embodiments, the read command may include a main read command for reading read-data and a spare read command for reading second spare-data.

In example embodiments, the storage device may transmit the read-data to the host device when the read-data are determined based on the main read command.

In example embodiments, the storage device may transmit the second spare-data related to spare-read-target-data to the host device when the spare-read-target-data are determined based on the spare read command.

In example embodiments, the storage device may transmit the read-data and the second spare-data related to the read-data to the host device when the read-data are determined based on the read command.

According to an aspect of example embodiments, a method of transmitting data between a host device including a host controller and a file system and a storage device including at least one NAND flash memory and a storage controller in a storage system is provided. The method may include an operation of determining, at the host device, write-data by a block unit on a logical address by generating a write command, an operation of gathering, at the host device, first spare-data related to the write-data to transmit the first spare-data to the storage device by a data transmission unit corresponding to a sector size, and an operation of transmitting, at the host device, the write-data to the storage device by the data transmission unit after transmitting the first spare-data to the storage device.

In example embodiments, the method may further include an operation of determining, at the host device, read-data by the block unit on the logical address by generating a main read command and an operation of transmitting, at the storage device, the read-data to the host device by the data transmission unit.

In example embodiments, the method may further include an operation of determining, at the host device, spare-read-target-data by the block unit on the logical address by generating a spare read command and an operation of transmitting, at the storage device, second spare-data related to the spare-read-target-data to the host device by the data transmission unit.

In example embodiments, the method may further include an operation of determining, at the host device, read-data by the block unit on the logical address by generating a read command and an operation of transmitting, at the storage device, the read-data and second spare-data related to the read-data to the host device by the data transmission unit.

Therefore, a storage system according to example embodiments may allow a host device to use a portion of a spare space of a physical page of a NAND flash memory included in a storage device while using a logical block-based interface. Specifically, since the host device can access spare-data stored in the storage device (i.e., can access the spare space of the physical page of the NAND flash memory included in the storage device) with little overhead in the storage system and meta-data in a range from few bytes to tens of bytes for performing a power-off recovery operation, a transaction operation, etc are stored in a portion of the spare space of the physical page of the NAND flash memory included in the storage device, a conventional unnecessary write operation for performing the power-off recovery operation, the transaction operation, etc may be prevented. Thus, performance and/or lifecycle of the storage system may be improved.

In addition, a method of transmitting data between a host device and a storage device in a storage system may efficiently transmit read-data/write-data (i.e., main-data) and spare-data related to the main-data between the host device and the storage device in the storage system.

### BRIEF DESCRIPTION OF THE DRAWINGS

Illustrative, non-limiting example embodiments will be more clearly understood from the following detailed description taken in conjunction with the accompanying drawings.

FIGS. 1A and 1B are block diagrams illustrating a storage system according to example embodiments.

FIG. 2A is a diagram illustrating write-data and spare-data related to the write-data to be transmitted from a host device to a storage device in the storage systems of FIGS. 1A and 1B.

FIG. 2B is a diagram illustrating an example embodiment in which write-data and spare-data related to the write-data are transmitted from a host device to a storage device in the storage systems of FIGS. 1A and 1B.

FIG. 2C is a diagram illustrating a physical page of a NAND flash memory into which the storage device writes write-data and spare-data related to the write-data in the storage systems of FIGS. 1A and 1B.

FIG. 3 is a flowchart illustrating an example embodiment in which a write operation for write-data and spare-data related to the write-data is performed by the storage systems of FIGS. 1A and 1B.

FIG. 4 is a diagram illustrating an example embodiment in which a write operation for write-data and spare-data related to the write-data is performed by the storage systems of FIGS. 1A and 1B.

FIG. 5 is a flowchart illustrating an example embodiment in which a read operation for read-data is performed by the storage systems of FIGS. 1A and 1B.

FIG. 6 is a diagram illustrating an example embodiment in which a read operation for read-data is performed by the storage systems of FIGS. 1A and 1B.

FIG. 7 is a flowchart illustrating an example embodiment in which a read operation for spare-data is performed by the storage systems of FIGS. 1A and 1B.

FIG. 8 is a diagram illustrating an example embodiment in which a read operation for spare-data is performed by the storage systems of FIGS. 1A and 1B.

### DETAILED DESCRIPTION OF THE EMBODIMENTS

Hereinafter, embodiments of the present inventive concept will be explained in detail with reference to the accompanying drawings.

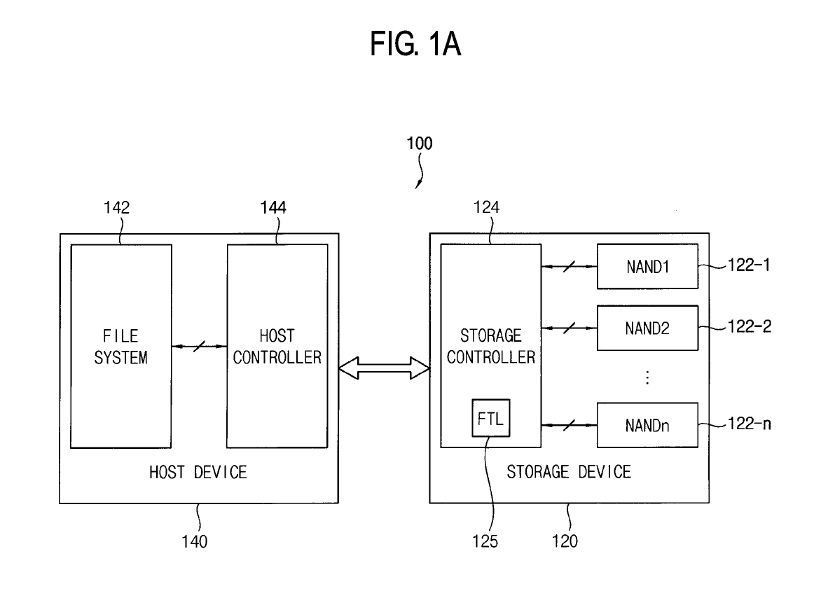

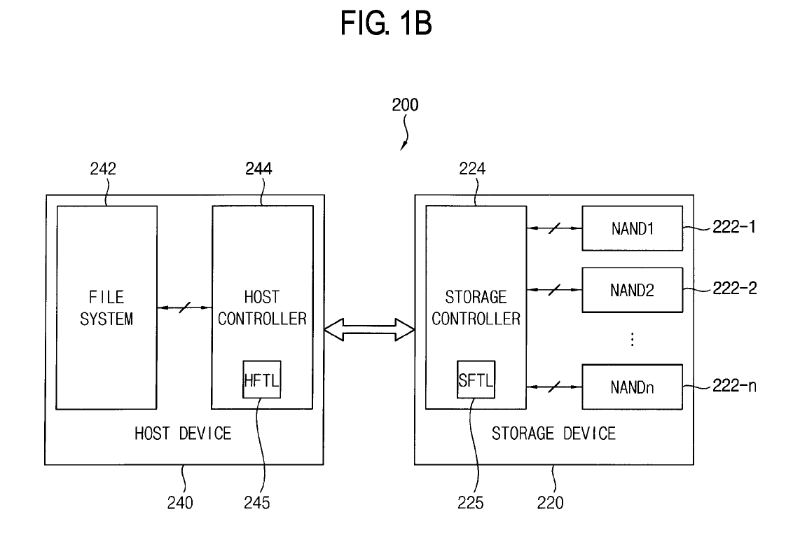

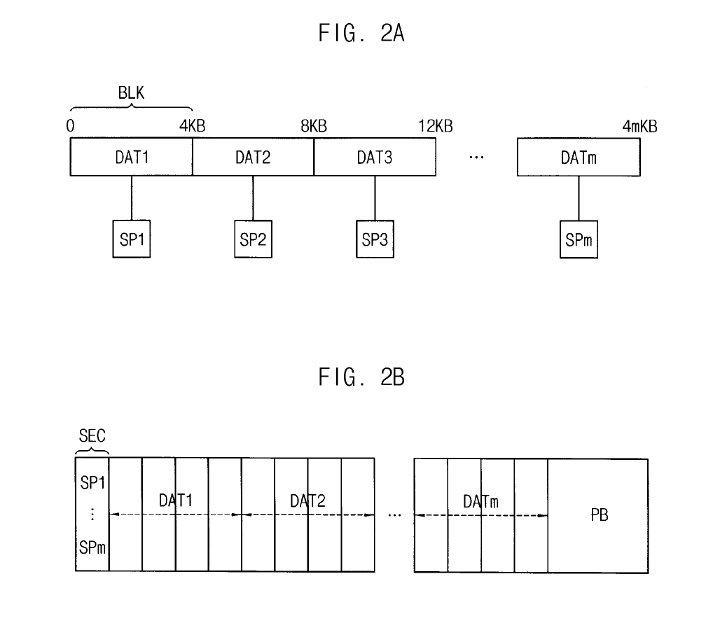

FIGS. 1A and 1B are block diagrams illustrating a storage system according to example embodiments. FIG. 2A is a diagram illustrating write-data and spare-data related to the write-data to be transmitted from a host device to a storage device in the storage systems of FIGS. 1A and 1B. FIG. 2B is a diagram illustrating an example embodiment in which write-data and spare-data related to the write-data are transmitted from a host device to a storage device in the storage systems of FIGS. 1A and 1B. FIG. 2C is a diagram illustrating a physical page of a NAND flash memory into which the storage device writes write-data and spare-data related to the write-data in the storage systems of FIGS. 1A and 1B.

Referring to FIGS. 1A through 2C, the storage system 100 or 200 may include a storage device 120 or 220 and a host device 140 or 240. Here, the storage device 120 or 220 may be a NAND flash memory device. For example, the storage device 120 or 220 may be implemented as a Solid State Drive (SSD), a Secure Digital Card (SDCARD), a Universal Flash Storage (UFS), an Embedded Multi Media Card (EMMC), a Compact Flash (CF) card, a memory stick, an eXtreme Digital (XD) picture card, etc. However, the storage device 120 or 220 is not limited thereto. Hereinafter, for convenience of description, the present inventive concept will be described focusing on the storage system 100 of FIG. 1A.

The storage device 120 may include first through (n)th NAND flash memories 122-1 through 122-n, where n is an integer greater than or equal to 1, and a storage controller 124. The storage controller 124 may interact with the first through (n)th NAND flash memories 122-1 through 122-n. Here, the storage controller 124 may control the first through (n)th NAND flash memories 122-1 through 122-n. Typically, due to physical characteristics of the first through (n)th NAND flash memories 122-1 through 122-n, the storage device 120 has more limits to perform a write operation, a read operation, and an erase operation than a random access memory device (e.g., a dynamic random access memory (DRAM) device, etc). Thus, the storage device 120 may perform a read operation, a write operation, an erase operation, a merge operation, a copy-back operation, a compaction operation, a garbage collection operation, a wear leveling operation, and the like by supporting the file system 142 based on a flash translation layer (i.e., executing the flash translation layer implemented as a software program). Here, the operations may be performed in a way that the flash translation layer performs, using a mapping table, an address mapping operation for translating a logical address of the file system 142 into a physical address of the first through (n)th NAND flash memories 122-1 through 122-n. In an example embodiment, as illustrated in FIG. 1A, the storage controller 124 of the storage device 120 may include a flash translation layer 125 that performs the address mapping operation. In another example embodiment, as illustrated in FIG. 1B, the host controller 244 of the host device 240 may include a host flash translation layer 245, the storage controller 244 of the storage device 220 may include a storage flash translation layer 225, and the host flash translation layer 245 and the storage flash translation layer 225 may perform the address mapping operation. It should be understood that the storage device 120 may further include other hardware and/or software components in addition to the storage controller 124 and the first through (n)th NAND flash memories 122-1 through 122-n.

The host device 140 may include the file system 142 and the host controller 144. The file system 142 may generate a read command or a write command for data by a block unit BLK on a logical address based on a logical block-based interface. In addition, the host controller 144 of the host device 140 interacts with the storage controller 124 of the storage device 120, so that the host device 140 may communicate with the storage device 120. Here, the file system 142 may be an Extended File System (Ext4), a New Technology File System (NTFS), etc. However, the file system 142 is not limited thereto. In some example embodiments, as illustrated in FIG. 1B, the host controller 244 may include the host flash translation layer 245 to perform some functions of the flash translation layer. In this case, since the host device 240 can detect internal operation information of the storage device 220 more accurately based on interactions between the file system 242 and the host controller 244, the host device 240 may efficiently support specific operations (e.g., a garbage collection operation, etc) performed in the storage device 220. It should be understood that the host device 140 may further include other hardware and/or software components in addition to the file system 142 and the host controller 144.

Since the storage system 100 operates based on the logical block-based interface, the read operation and the write operation are performed by the block unit BLK in the host device 140 while the read operation and the write operation are performed by a specific unit that is a multiple of a physical page PHY-PAGE of the first through (n)th NAND flash memories 122-1 through 122-n (i.e., that is greater than the block unit BLK) in the storage device 120. In addition, the data are received and transmitted between the host device 140 and the storage device 120 by a data transmission unit SEC corresponding to a sector size. For example, the sector size may be 512 bytes. That is, the sector size may be smaller than the block unit BLK and a size of the physical page PHY-PAGE of the first through (n)th NAND flash memories 122-1 through 122-n. Thus, in a conventional storage system, even when meta-data in a range from few bytes to tens of bytes are written to perform the power-off recovery operation, the transaction operation, etc, the host device 140 needs to request the write operation to be performed on an additional block, and thus the request causes the storage device 120 to perform the write operation on an additional physical page PHY-PAGE. To overcome this problem, the host device 140 and the storage device 120 may receive and transmit the data by the data transmission unit SEC corresponding to the sector size in the storage system 100. In addition, when write-data DAT1 through DATm, where m is an integer greater than or equal to 1, are determined based on the write command, the host device 140 may transmit the write-data DAT1 through DATm to the storage device 120 after gathering and transmitting spare-data SP1 through SPm related to the write-data DAT1 through DATm to the storage device 120.

FIG. 2A shows the write-data DAT1 through DATm and the spare-data SP1 through SPm related to the write-data DAT1 through DATm to be transmitted from the host device 140 to the storage device 140. As illustrated in FIG. 2A, the write-data DAT1 through DATm may be handled (or, processed) by the block unit BLK on the logical address. Here, the write-data DAT1 through DATm may be referred to as main-data. The write-data DAT1 through DATm may be related to the spare-data SP1 through SPm, respectively. Although it is illustrated in FIG. 2A that the block unit BLK is 4 KB, the block unit BLK is not limited thereto. In an example embodiment, the spare-data SP1 through SPm may include information for performing the power-off recovery operation in connection with the write-data DAT1 through DATm. For example, the information for performing the power-off recovery operation may be information about a file name, an offset in the file, and the like when the information for performing the power-off recovery operation is used by the file system 142. For example, the information for performing the power-off recovery operation may be information about a logical page number and the like when the information for performing the power-off recovery operation is used by the host controller 244 that performs some functions of the flash translation layer. In another example embodiment, the spare-data SP1 through SPm may include information for performing the transaction operation in connection with the write-data DAT1 through DATm. For example, the information for performing the transaction operation may be information about identification (ID) of the transaction, a start/end of the transaction, a data checksum in the transaction, and the like. However, the information included in the spare-data SP1 through SPm is not limited thereto.

FIG. 2B shows that the write-data DAT1 through DATm and the spare-data SP1 through SPm related to the write-data DAT1 through DATm are transmitted from the host device 140 to the storage device 120. As illustrated in FIG. 2B, the write-data DAT1 through DATm and the spare-data SP1 through SPm may be received and transmitted between the host device 140 and the storage device 120 by the data transmission unit SEC corresponding to the sector size that is smaller than a block size. Here, when the write-data DAT1 through DATm are determined, the host device 140 may gather the spare-data SP1 through SPm related to the write-data DAT1 through DATm, may transmit the spare-data SP1 through SPm to the storage device 120, and then may transmit the write-data DAT1 through DATm to the storage device 120. In some example embodiments, as illustrated in FIG. 2B, padding bytes PB may be inserted. Although it is illustrated in FIG. 2B that a total size of the spare-data SP1 through SPm is smaller than the data transmission unit SEC corresponding to the sector size (i.e., all spare-data SP1 through SPm are gathered in one data transmission unit SEC), the total size of the spare-data SP1 through SPm may be bigger than the data transmission unit SEC corresponding to the sector size. For example, when the total size of the spare-data SP1 through SPm is bigger than the data transmission unit SEC corresponding to the sector size, all spare-data SP1 through SPm may be gathered in at least two data transmission units SEC. Even in this case, the spare-data SP1 through SPm may be transmitted to the storage device 120 earlier than the write-data DAT1 through DATm. In some example embodiments, the storage system 100 may use a packed command supported by eMMC, which is a command generated by packing the read command and the write command to transmit them to the storage device 120 together. For example, when the storage system 100 uses the packed command supported by eMMC, the spare-data SP1 through SPm may be loaded into a remaining space of a header of the packed command to be transmitted to the storage device 120. In addition, when the storage system 100 uses the packed command supported by eMMC, the first write command of the packed command may be utilized to transmit the spare-data SP1 through SPm to the storage device 120.

FIG. 2C shows the physical page PHY-PAGE of the first through (n)th NAND flash memories 122-1 through 122-n into which the storage device 120 writes the write-data DAT1 through DATm and the spare-data SP1 through SPm related to the write-data DAT1 through DATm. As illustrated in FIG. 2C, the physical page PHY-PAGE may include a main space MAIN SPACE and a spare space SPARE SPACE. Here, data may be written into the main space MAIN SPACE. In addition, error correction codes (ECC) for performing an error correction operation, additional information of the flash translation layer, etc may be written into the spare space SPARE SPACE. However, in the storage system 100, the storage device 120 may write the main-data DAT1 through DATm into the main space MAIN SPACE and may write the spare-data SP1 through SPm related to the main-data DAT1 through DATm into a portion of the spare space SPARE SPACE. In other words, the storage device 120 may write the spare-data SP1 through SPm related to the main-data DAT1 through DATm as well as the error correction codes, the additional information of the flash translation layer, etc into the spare space SPARE SPACE. Thus, the host device 140 may receive the main-data DAT1 through DATm and the spare-data SP1 through SPm from the storage device 120 by generating a main read command for reading the main-data DAT1 through DATm stored in the main space MAIN SPACE of the physical page PHY-PAGE and a spare read command for reading the spare-data SP1 through SPm stored in the spare space SPARE SPACE of the physical page PHY-PAGE.

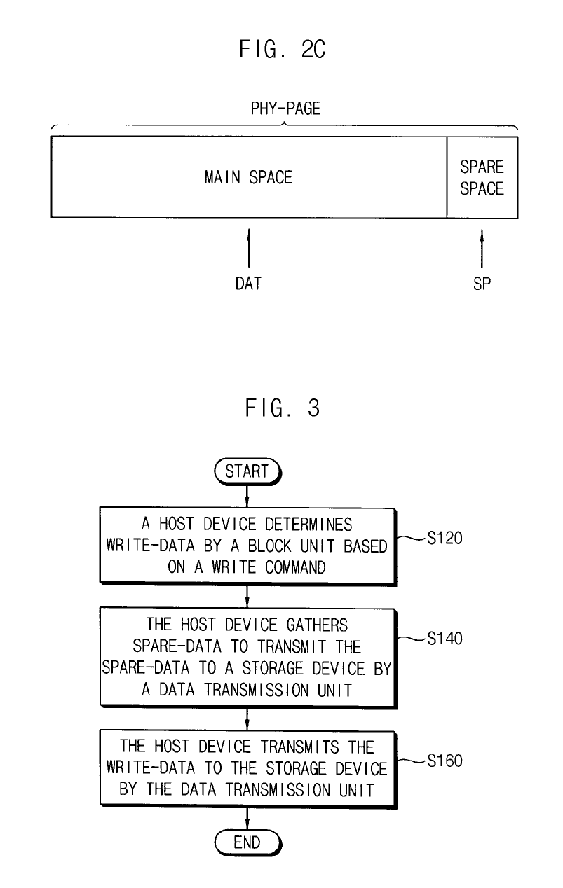

As described above, the storage system 100 may allow the host device 140 to use a portion of the spare space SPARE SPACE of the physical page PHY-PAGE of the first through (n)th NAND flash memories 122-1 through 122-n included in the storage device 120 while using the logical block-based interface. Specifically, since the host device 140 can access the spare-data SP1 through SPm stored in the storage device 120 with little overhead in the storage system 100 (i.e., can access the spare space SPARE SPACE of the physical page PHY-PAGE of the first through (n)th NAND flash memories 122-1 through 122-n included in the storage device 120) and the meta-data in a range from few bytes to tens of bytes for performing the power-off recovery operation, the transaction operation, etc are stored in a portion of the spare space SPARE SPACE of the physical page PHY-PAGE of the first through (n)th NAND flash memories 122-1 through 122-n included in the storage device 120, a conventional unnecessary write operation for performing the power-off recovery operation, the transaction operation, etc may be prevented. Thus, performance and/or lifecycle of the storage system 100 may be improved. In addition, when the file system 142 included in the host device 140 is a journaling file system (i.e., when a journaling operation is performed in the storage system 100), the performance and/or the lifecycle of the storage system 100 may also be improved because a size of journaling data is reduced. For example, the present inventive concept may be applied to a journaling operation of Ext4 or SQLite. However, the present inventive concept is not limited thereto. Although it is described above that the spare-data SP1 through SPm are stored in the spare space SPARE SPACE of the physical page PHY-PAGE of the first through (n)th NAND flash memories 122-1 through 122-n, the spare-data SP1 through SPm may be stored in an additional physical page PHY-PAGE of the first through (n)th NAND flash memories 122-1 through 122-n or may be stored in an additional non-volatile memory (e.g., a phase-change random access memory (PRAM), a magnetic random access memory (MRAM), etc) included in the storage device 120. Hereinafter, the read and write operations of the storage system 100 will be described in detail with reference to FIGS. 3 through 8.

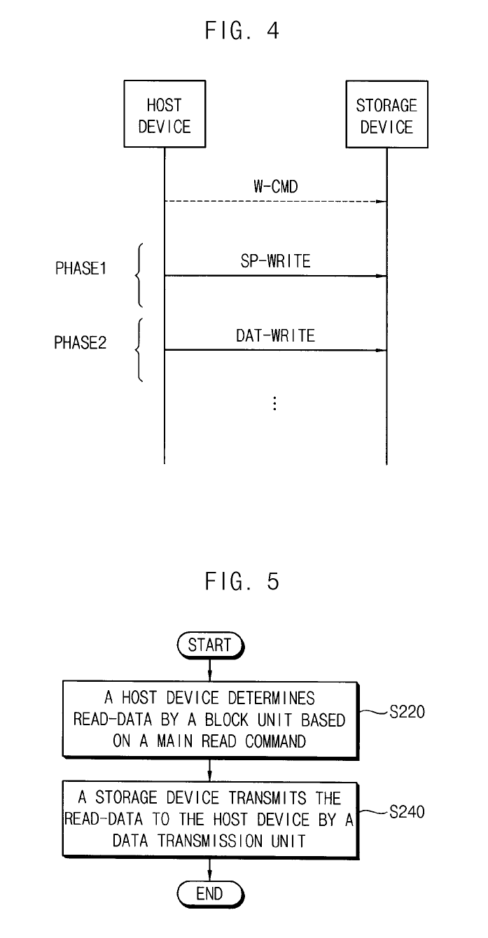

FIG. 3 is a flowchart illustrating an example embodiment in which a write operation for write-data and spare-data related to the write-data is performed by the storage systems of FIGS. 1A and 1B. FIG. 4 is a diagram illustrating an example embodiment in which a write operation for write-data and spare-data related to the write-data is performed by the storage systems of FIGS. 1A and 1B.

Referring to FIGS. 3 and 4, it is illustrated that the write operation for the write-data and the spare-data related to the write-data is performed by the storage system 100 or 200. Specifically, the host device 140 or 240 may determine the write-data by a block unit on a logical address by generating a write command (i.e., indicated as W-CMD) (S120), may gather the spare-data related to the write-data to transmit the spare-data to the storage device 120 or 220 by a data transmission unit corresponding to a sector size (i.e., indicated as SP-WRITE) (S140), and then may transmit the write-data to the storage device 120 or 220 by the data transmission unit (i.e., indicated as DAT-WRITE) (S160). As illustrated in FIG. 4, a data transmission in the storage system 100 or 200 may be completed by sequentially performing a first phase PHASE1 in which the spare-data are transmitted and a second phase PHASE2 in which the write-data are transmitted. Although it is illustrated in FIG. 4 that the host device 140 or 240 sequentially performs the first phase PHASE1 and the second phase PHASE2 based on the write command, the write command may include a main write command for writing the write-data (e.g., referred to as a ‘write data command’) and a spare write command for writing the spare-data related to the write-data (e.g., referred to as a ‘send spare for succeeding writes command’). When the write command includes the main write command and the spare write command, the spare-data related to the write-data may be transmitted to the storage device 120 or 220 based on the spare write command in the first phase PHASE1, and the write-data may be transmitted to the storage device 120 or 220 based on the main write command in the second phase PHASE2. In some example embodiments, the write command may include information about a start sector address of the write-data, the number of sectors of the write-data, and the like. As described above, in the storage system 100 or 200, the host device 140 or 240 may transmit the write-data and the spare-data related to the write-data to the storage device 120 or 220 by rearranging (or, reordering) the write-data and the spare-data related to the write-data.

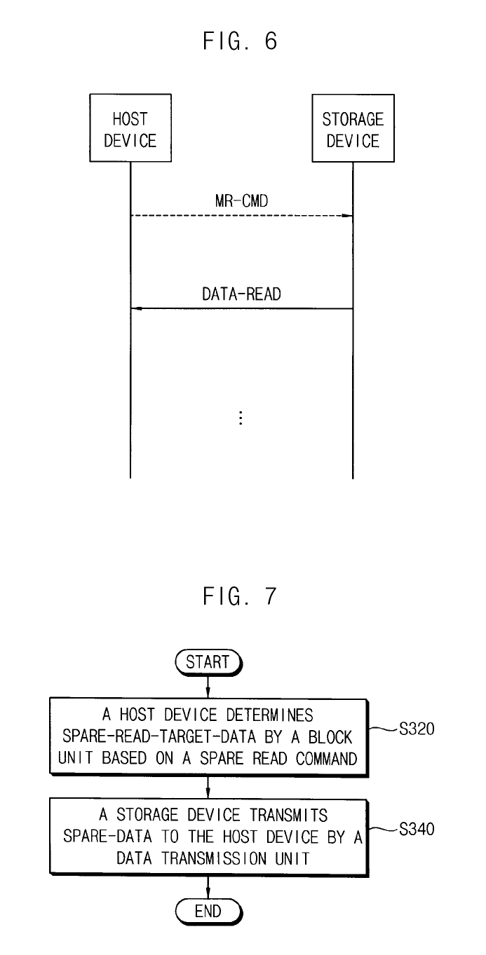

FIG. 5 is a flowchart illustrating an example embodiment in which a read operation for read-data is performed by the storage systems of FIGS. 1A and 1B. FIG. 6 is a diagram illustrating an example embodiment in which a read operation for read-data is performed by the storage systems of FIGS. 1A and 1B.

Referring to FIGS. 5 and 6, it is illustrated that the read operation for the read-data is performed by the storage system 100 or 200. In some example embodiments, a read command may include a main read command for reading the read-data (e.g., referred to as a ‘read data command’) and a spare read command for reading spare-data related to spare-read-target-data (e.g., referred to as a ‘read spare data command’). As a result, in the storage system 100 or 200, the host device 140 or 240 may separately (or, directly) access the read-data and the spare-data stored in the storage device 120 or 220. Specifically, as illustrated in FIG. 6, when the host device 140 or 240 determines the read-data by a block unit on a logical address by generating the main read command (i.e., indicated as MR-CMD) (S220), the storage device 120 or 220 may transmit the read-data to the host device 140 or 240 by a data transmission unit (i.e., indicated as DATA-READ) (S240). Here, the main read command may include information about a start sector address of the read-data, the number of sectors of the read-data, and the like. As described above, in the storage system 100 or 200, the host device 140 or 240 may receive the read-data from the storage device 120 or 220 in the same way as a conventional storage system. In some example embodiments, when the host device 140 or 240 determines the read-data by the block unit on the logical address by generating the read command, the storage device 120 or 220 may transmit the read-data and spare-data related to the read-data to the host device 140 or 240 by the data transmission unit.

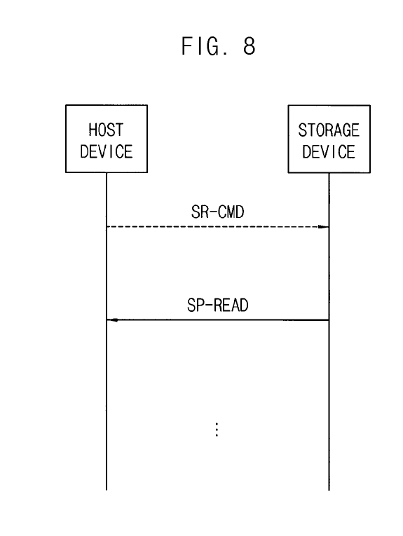

FIG. 7 is a flowchart illustrating an example embodiment in which a read operation for spare-data is performed by the storage systems of FIGS. 1A and 1B. FIG. 8 is a diagram illustrating an example embodiment in which a read operation for spare-data is performed by the storage systems of FIGS. 1A and 1B.

Referring to FIGS. 7 and 8, it is illustrated that the read operation for the spare-data related to spare-read-target-data is performed by the storage system 100 or 200. In some example embodiments, a read command may include a main read command for reading the read-data (e.g., referred to as a ‘read data command’) and a spare read command for reading the spare-data related to the spare-read-target-data (e.g., referred to as a ‘read spare data command’). As a result, in the storage system 100 or 200, the host device 140 or 240 may separately (or, directly) access the read-data and the spare-data stored in the storage device 120 or 220. Specifically, as illustrated in FIG. 8, when the host device 140 or 240 determines the spare-read-target-data by a block unit on a logical address by generating the spare read command (i.e., indicated as SR-CMD) (S320), the storage device 120 or 220 may transmit the spare-data related to the spare-read-target-data to the host device 140 or 240 by a data transmission unit (i.e., indicated as SP-READ) (S340). Here, the spare read command may include information about a start sector address of the spare-read-target-data, the number of sectors of the spare-read-target-data, and the like. In example embodiments, a total size of the spare-data that the host device 140 or 240 receives from the storage device 120 or 220 may be calculated using [Equation 1] below:

$$R B = ( \frac{S M D}{S Z} ) \times S B P S , \qquad [ Equation 1 ]$$

where RB denotes the total size of the spare-data that the host device 140 or 240 receives from the storage device 120 or 220, SMD denotes a total size of the spare-read-target-data, SZ denotes a sector size, a block size, a page size, or a specific unit, SBPS denotes a size of the spare-data per sector, a size of the spare-data per block, a size of the spare-data per page, or a size of the spare-data per specific unit.

As described above, the storage system 100 or 200 may allow the host device 140 or 240 to use a portion of a spare space of a physical page of a NAND flash memory included in the storage device 120 or 220 while using a logical block-based interface. Thus, the host device 140 or 240 may separately (or, directly) access the read-data and the spare-data stored in the storage device 120 or 220. As a result, in the storage system 100 or 200, when meta-data in a range from few bytes to tens of bytes for performing a power-off recovery operation, a transaction operation, etc are stored in a portion of the spare space of the physical page of the NAND flash memory included in the storage device 120 or 220, a conventional unnecessary write operation for performing the power-off recovery operation, the transaction operation, etc may be prevented. Thus, performance and/or lifecycle of the storage system 100 or 200 may be improved. In addition, read-data/write-data (i.e., main-data) and spare-data related to the main-data may be efficiently transmitted between the host device 140 or 240 and the storage device 120 or 220 in the storage system 100 or 200. Although a storage system and a method of transmitting data between a host device and a storage device in a storage system according to example embodiments have been described with reference to FIGS. 1A through 8, those skilled in the art will readily appreciate that many modifications are possible in the example embodiments without materially departing from the novel teachings and advantages of the present inventive concept.

The present inventive concept may be applied to a storage system including a storage device (i.e., a NAND flash memory device). For example, the present inventive concept may be applied to a Solid State Drive (SSD), a Secure Digital Card (SDCARD), a Universal Flash Storage (UFS), an Embedded Multi Media Card (EMMC), a Compact Flash (CF) card, a memory stick, an eXtreme Digital (XD) picture card, etc.

The foregoing is illustrative of example embodiments and is not to be construed as limiting thereof. Although a few example embodiments have been described, those skilled in the art will readily appreciate that many modifications are possible in the example embodiments without materially departing from the novel teachings and advantages of the present inventive concept. Accordingly, all such modifications are intended to be included within the scope of the present inventive concept as defined in the claims. Therefore, it is to be understood that the foregoing is illustrative of various example embodiments and is not to be construed as limited to the specific example embodiments disclosed, and that modifications to the disclosed example embodiments, as well as other example embodiments, are intended to be included within the scope of the appended claims.

What is claimed is:

1. A storage system comprising:
a storage device including at least one NAND flash memory and a storage controller that controls the NAND flash memory; and
a host device including a host controller that interacts with the storage controller and a file system that generates a read command or a write command for data by a block unit on a logical address,
wherein when the read command or the write command for the data is generated, the host device and the storage device receive and transmit the data by a data transmission unit corresponding to a sector size, and
wherein when write-data are determined based on the write command, the host device transmits the write-data to the storage device after gathering and transmitting first spare-data related to the write-data to the storage device.

2. The system of claim 1, wherein the storage controller includes a flash translation layer that performs an address mapping operation.

3. The system of claim 1, wherein the host controller includes a host flash translation layer, the storage controller includes a storage flash translation layer, and the host flash translation layer and the storage flash translation layer perform an address mapping operation.

4. The system of claim 1, wherein the storage device writes the write-data into a main space of a physical page of the NAND flash memory and writes the first spare-data into a portion of a spare space of the physical page.

5. The system of claim 4, wherein the first spare-data includes information for performing a power-off recovery operation in connection with the write-data.

6. The system of claim 4, wherein the first spare-data includes information for performing a transaction operation in connection with the write-data.

7. The system of claim 1, wherein the read command includes a main read command for reading read-data and a spare read command for reading second spare-data.

8. The system of claim 7, wherein the storage device transmits the read-data to the host device when the read-data are determined based on the main read command.

9. The system of claim 7, wherein the storage device transmits the second spare-data related to spare-read-target-data to the host device when the spare-read-target-data are determined based on the spare read command.

10. The system of claim 7, wherein the storage device transmits the read-data and the second spare-data related to the read-data to the host device when the read-data are determined based on the read command.

11. A method of transmitting data between a host device including a host controller and a file system and a storage device including at least one NAND flash memory and a storage controller in a storage system, the method comprising:
determining, at the host device, write-data by a block unit on a logical address by generating a write command;
gathering, at the host device, first spare-data related to the write-data to transmit the first spare-data to the storage device by a data transmission unit corresponding to a sector size; and
transmitting, at the host device, the write-data to the storage device by the data transmission unit after transmitting the first spare-data to the storage device.

12. The method of claim 11, further comprising:
determining, at the host device, read-data by the block unit on the logical address by generating a main read command; and
transmitting, at the storage device, the read-data to the host device by the data transmission unit.

13. The method of claim 11, further comprising:
determining, at the host device, spare-read-target-data by the block unit on the logical address by generating a spare read command; and
transmitting, at the storage device, second spare-data related to the spare-read-target-data to the host device by the data transmission unit.

14. The method of claim 11, further comprising:
determining, at the host device, read-data by the block unit on the logical address by generating a read command; and
transmitting, at the storage device, the read-data and second spare-data related to the read-data to the host device by the data transmission unit.
